(19) United States
(12) Patent Application Publication
(10) Pub. No.: US 2018/0206078 A1
(43) Pub. Date: Jul. 19, 2018

(54) METHOD AND APPARATUS FOR HANDLING BUILDING PRESSURIZATION DURING INDOOR POSITIONING

(71) Applicant: QUALCOMM Incorporated, San Diego, CA (US)

(72) Inventors: Sai Pradeep Venkatraman, Santa Clara, CA (US); Weihua Gao, San Jose, CA (US); Gengsheng Zhang, Cupertino, CA (US)

(21) Appl. No.: 15/406,258

(22) Filed: Jan. 13, 2017

(51) Int. Cl. H04W 4/04; G01C 21/20; G01C 5/06

(52) U.S. Cl. CPC H04W 4/043; G01C 5/06; G01C 21/206

(57) ABSTRACT

Disclosed is a method and apparatus for utilizing pressure sensor reliability during indoor positioning performed by a mobile device. The method may include performing an indoor positioning process on the mobile device to estimate a current location of the mobile device within an indoor environment. The method may also include analyzing a mapping between indoor positions and pressure sensor measurement reliability. Furthermore, the method may also include altering a usage of pressure sensor measurements collected by the mobile device for the indoor positioning process at the current estimated location of the mobile device within the indoor environment responsive to the mapping indicating that the estimated current location of the mobile device within the indoor environment is associated with an unreliability of pressure sensor measurements.

### FIELD

The subject matter disclosed herein relates generally to performing indoor positioning by a mobile device.

### BACKGROUND

Positioning processes can be used by mobile devices indoors. Often a map of an indoor environment associated with, or linked to, assistance data is used to provide indoor positioning services to a user. These indoor positioning services may include displaying a map of an indoor environment (e.g., a building floorplan), an indication of where a user/mobile device is located within the indoor environment, an indication of which floor a user/mobile device is located on in a multi-level indoor environment, etc. The map and the user's location may be used as the basis for providing additional services, such as navigation/direction services within the indoor environment.

One complication for indoor positioning includes determining what floor a user is located on as well as determining when a user has transitioned between floors. Some techniques for determining on which floor a user is located include the mobile device capturing signals form one or more wireless transmitters (e.g., wireless fidelity access points) associated with specific floors, and inferring the user's current floor/altitude from this information. Another technique includes measuring a barometric pressure by the mobile device, and estimating what floor the user is located on based on a characteristic value, such as altitude, of the barometric pressure.

When using barometric pressure as a way to determine a user's current floor, certain factors can lead to inaccurate conclusions. For example, a building may be pressurized to support environmental control systems (e.g., heating, ventilation, and air conditioning systems). Furthermore, an air pressure within an entire indoor environment and/or within specific zones of the indoor environment may be affected by the environmental control systems. Similarly, different zones of an indoor environment, even when at the same level/floor, may have different pressurizations due to the inputs and outputs of an environmental control system. Thus, use of barometric pressure when deciding on which level a user is currently located and/or providing additional indoor positioning services may lead to inaccurate results.

### BRIEF DESCRIPTION OF THE DRAWINGS

FIG. 1 is a block diagram of an exemplary system architecture for utilizing pressure sensor reliability during indoor positioning performed by a mobile device;

FIG. 2 is block diagram of one embodiment of a mobile device and an assistance server;

FIG. 3 is a flow diagram of one embodiment of a method for utilizing barometric pressure sensor reliability data while performing an indoor positioning process;

FIG. 4 is a flow diagram of one embodiment of a method for generating one or more types of barometric pressure sensor reliability data for use during an indoor positioning process;

FIG. 5 shows an example of barometric pressure changes due to level transitions and due to environmental control systems;

FIG. 6 shows an example of one embodiment of assistance data in the form of a floor plan and mappings to potential areas of barometric unreliability; and

FIG. 7 shows an example of another embodiment of assistance data in the form of a mapping of physical locations to barometric unreliability.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

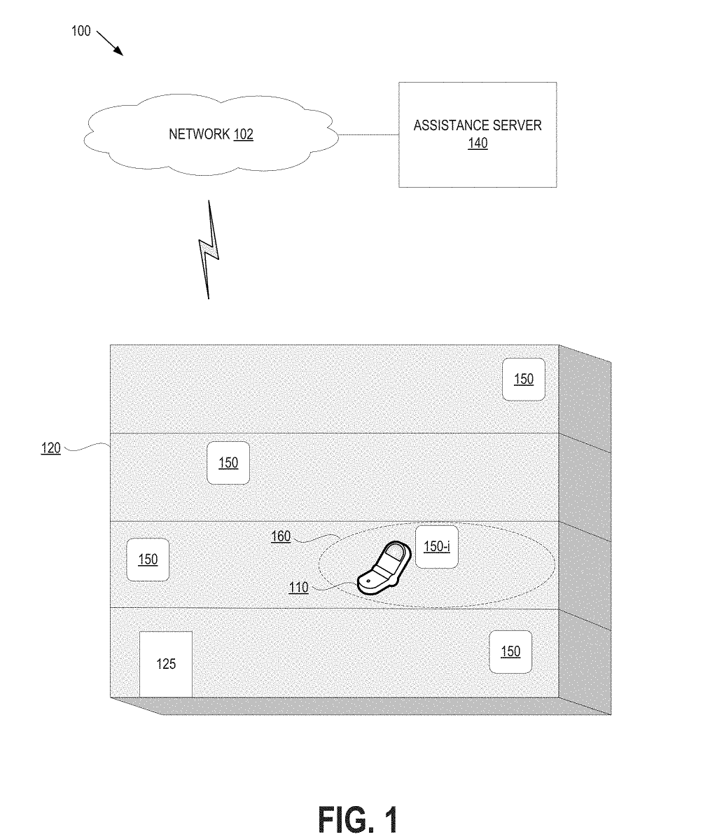

FIG. 1 is a block diagram of an exemplary system architecture for utilizing pressure sensor reliability during indoor positioning performed by a mobile device.

In one embodiment, the system 100 includes a mobile device 110 and an assistance server 140. In one embodiment, mobile device 110 may be a mobile computing device, such as a mobile telephone, personal digital assistant, tablet computer, wearable device, etc. Assistance server 140 may also be one or more computing devices, such as one or more server computer systems, desktop computer systems, etc. The mobile device 110 and assistance server 140 may be communicably coupled to a network 102 and communicate with one another using any of the standard protocols for the exchange of information. In one embodiment, mobile device 110 and assistance server 140 may communicate with one another over one Local Area Network (LAN), different LANs, wide area networks, cellular telephone networks, etc. that may be coupled together via the Internet but separated by firewalls, routers, and/or other network devices. Furthermore, in one embodiment, assistance server 140 may reside on a single computing device (e.g., a server computer system), or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, mobile device 110 performs indoor positioning while inside and/or prior to entering a multi-level physical structure 120, such as an office building, shopping mall, university building, etc. The indoor positioning can include one or more of displaying a map of the indoor environment (e.g., a building floorplan) of physical structure 120, determining and displaying an indication of where mobile device 110 is located within physical structure 120, determining and displaying an indication of which floor a user/mobile device is located on in a multi-level indoor environment, providing location based services within the physical structure 120 such as location based search, indoor navigation, etc., as well as other indoor positioning processes.

In one embodiment, mobile device 110 includes a pressure sensor (not shown), such as a barometric sensor, for measuring ambient air pressure while outside and inside physical structure 120. In one embodiment, from the determined ambient air pressure, mobile device 110 estimates a height/altitude of the mobile device 110, such as a height estimate based on a difference between the measured air pressure and a reference air pressure (e.g., air pressure at sea level, a ground level air pressure associated with physical structure 120, etc.). In one embodiment, mobile device 110 utilizes pressure sensor measurements and associated estimates while performing indoor positioning to distinguish between different levels of a multi-level indoor environment, such as physical structure 120.

In one embodiment, prior to performing indoor positioning within physical structure 120, or at the initiation of an indoor positioning process, mobile device 110 obtains assistance data from assistance server 140. The assistance data is utilized by mobile device 110 when performing indoor positioning within physical structure, and may include floor plans, building layouts, building information, location based information (e.g., landmarks, points of interest, etc.), etc.

In one embodiment, due to the issues caused by environmental control systems, in one embodiment, the indoor positioning assistance data may include a mapping of data indicative of the reliability of a pressure sensor measurement at different physical locations within structure 120. This mapping may be used when determining a current level of the mobile device 110 during an indoor positioning process. In one embodiment, the mapping is provided within the indoor positioning assistance data (e.g., enhanced indoor positioning assistance data). In another embodiment, the mapping is provided as a different set of assistance data (e.g., pressure sensor measurement assistance data). In either embodiment, physical structure's 120 environmental control system may include a plurality of environmental control system components 150, such as intakes, outputs, etc. Because intakes, outputs, etc. may alter the pressure of a region surrounding, for example, an output blowing cold air from an air conditioner's compressor, certain locations, zones, regions, floors, portions of floors, etc. within physical structure 120 may lead to pressure sensor measurements that do not reflect the expected ambient air pressure associated for an actual height (e.g. floor) at which the mobile device 110 is located.

In one embodiment, point locations, regions, or other areas (e.g., area 160) of indoor positioning assistance data supplied by assistance server 140 may be associated with data indicative of the lack of reliability of a pressure sensor measurement. That is, these points, regions, areas, etc. are areas within physical structure 120 where pressure sensor measurements are known or expected to be inaccurate, and should be discounted, devalued, or even disregarded by mobile device 110 during indoor positioning.

In one embodiment, the points, regions, or other areas that exhibit pressure sensor measurement unreliability may be determined as a result of an off-line finger printing process performed for physical structure 120, such as when a pressure reading (e.g., elevation) collected by a fingerprinting device (not shown) for the point, region, or area exceeds an expected pressure reading by a threshold amount. The fingerprinting data and associated pressure sensor readings, as well as unexpected deviations (e.g., unreliable locations, zones, regions, etc.), enable assistance server 140 to generate indoor positioning assistance data enhanced with pressure sensor unreliability mapped to physical location(s) within physical structure 120. For example, the indoor positioning assistance data may identify the areas on the same level of an indoor environment with different air pressures caused by, for example, A/C outlets and intakes, such as area 160 caused by A/C outlet 150-i.

The identification and association of locations of physical structure 120 in the indoor positioning assistance data that lack reliability when obtaining pressure sensor measurements may also be generated from crowdsourced, or collected pressure sensor measurements, of a plurality of mobile devices, such as mobile device 110. In one embodiment, such collected or crowdsourced pressure data may be correlated by assistance server 140 with known internal environment locations (e.g., locations of physical structure 120 determined from indoor positioning assistance) to provide relative barometric pressures for certain locations and levels of an indoor environment. In another embodiment, relative pressure sensor readings of crowdsourcing mobile devices may be correlated with base pressure sensor readings to infer different levels, and thus locations on those levels. Then, based on a known indoor environment, floor plan, and known altitude at locations within the indoor environment, the collected deviations in pressure for a given floor plan can be used by assistance server 140 to determine areas of unreliability of air pressure sensor measurements where there is a significant deviation from the known altitude. For example, if a minimum number of mobile devices report an unexpected drop in air pressure above a threshold amount (e.g., beyond an expected statistical deviation, such as ½, 1, 2, etc. standard deviations from an expected pressure sensor measurement) for the known level of a multi-level indoor environment, that location, zone, floor, wing, etc. associated with the unexpected deviation can be identified as being associated with an indication of unreliability of barometric pressure measurements, and mapped to unreliability within indoor positioning assistance data provided from assistance server 140 to mobile device 110.

In one embodiment, the data indicative of the lack of reliability of a pressure sensor measurement may be provided as a separate indoor positioning barometric reliability assistance data (e.g., a barometric reliability heat map, a binary mapping of locations with barometric reliability, a listing of locations, zones, etc. that are mapped to unreliable pressure sensor measurements, etc.), which maps points and/or locations to indications of the reliability of pressure sensor measurements at the given points and/or locations. Alternatively, barometric reliability may be included within existing indoor positioning assistance data (e.g., within a radio heat map that enables mobile device 110 to determine its indoor position from received radio, wireless fidelity, etc. signals and associated signal characteristics). The indoor positioning assistance data and/or pressure sensor measurement assistance data may be obtained by a mobile device 110 from assistance server 140, as well as from other systems (e.g., a navigation service), and used by mobile device 110 when performing indoor positioning. For example, mobile device may use indoor positioning assistance data (e.g., a radio heat map and/or barometric pressure sensor measurements) to determine what level a mobile device is on. In one embodiment, however, the reliability data included within the indoor positioning assistance data, or as separate indoor positioning assistance data, enables mobile device 110 to determine when to discount or disregard pressure sensor measurements when determining an indoor position of mobile device within physical structure 120. That is, when a location determined by mobile device 110 from indoor positioning assistance data is mapped to pressure sensor measurement unreliability, mobile device 110 utilizes this mapping as a control to disregard the pressure sensor measurement and perform indoor positioning without pressure sensor measurements while the mobile device 110 is located within an a zone of unreliability (e.g., area 160). Furthermore, in one embodiment, mobile device 110 may use the determined mapping of its current location to a zone or pressure sensor measurement unreliability to turn off a pressure sensor used by mobile device 110 for the collection of pressure sensor measurements in order to conserve power and increase indoor positioning determination efficiency by discontinuing the use of pressure sensor measurements. In one embodiment, when mobile device 110 leaves the zone of unreliability (e.g., leaves area 160), mobile device 110 may again use pressure sensor measurements when determining a location within physical structure 120.

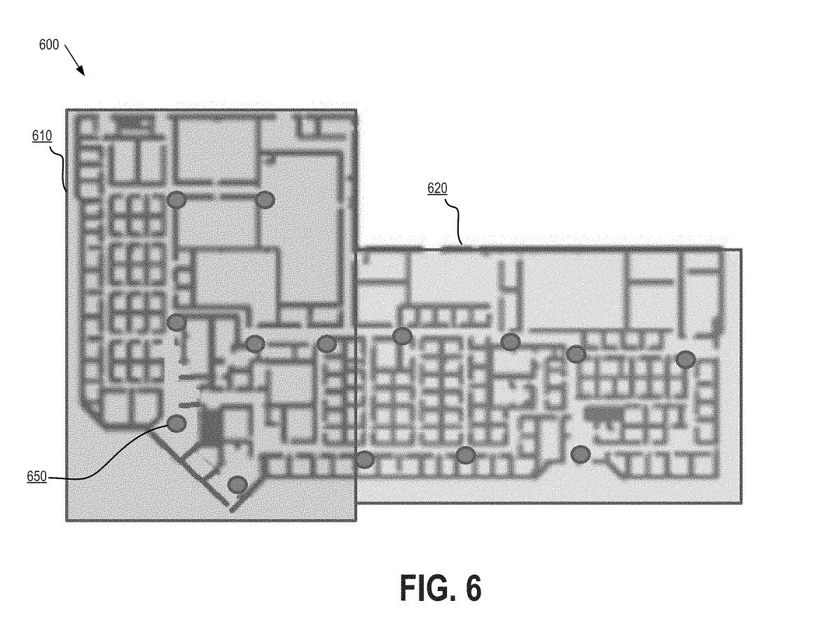

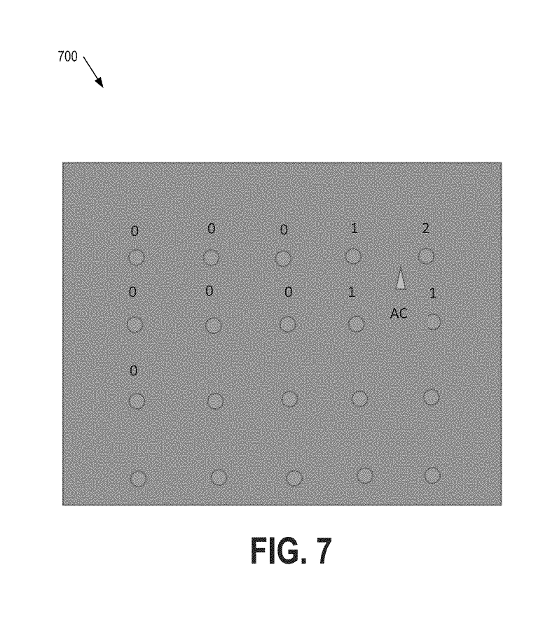

For example, FIG. 6 shows an example of one embodiment of assistance data 600 in the form of a floor plan and potential areas of barometric unreliability, such as an area proximate to a/c intake/outlet 650. Furthermore, a first region 610 and a second region 620 of the floor plan may also be associated with potential differences in barometric pressure unreliability. In embodiments, the avoidance of use of the pressure sensor may be temporary (e.g., when the mobile device's 110 position within physical structure 120 moves to within a certain distance from a/c intake/outlet 650), semi-permanent (e.g., when a floor or wing is associated with unreliability of pressure sensor measurements, such as when mobile device 110 is located within region 620), etc. As another example, FIG. 7 shows another embodiment of assistance data 700 in the form of a mapping of physical locations to barometric unreliability. In one embodiment, the mapping of physical locations may include a grid of points associated with physical locations of a physical structure, and values (e.g., 0, 1, 2, etc.) associated with an unreliability score at the corresponding points/locations. In embodiments, the values associated with points enable mobile device 110 to determine, based on the value of a zone in which the mobile device is currently located and/or values of surrounding zones, that the mobile device is located in an area of pressure sensor measurement unreliability, and take one of the actions discussed herein.

Returning to FIG. 1, in one embodiment, indoor positioning assistance data (e.g., with integrated pressure sensor measurement reliability information or as separate pressure sensor reliability assistance data) may also assist the mobile device in determining an initial or base pressure when entering 125 physical structure 120. As discussed above, some structures/indoor environments may be positively pressured by an environmental control system. Thus, pressure measured outside physical structure 120 and then inside physical structure 120 indicate a relative altitude change that mobile device will experience (with respect to pressure sensor measurements), even when none is present. In one embodiment, evidence of such a pressure change can be detected during the offline fingerprinting process and/or by mobile device crowdsourcing discussed above. The pressure difference between an altitude outside of physical structure 120 and an altitude based on a measured air pressure inside physical structure 120 may then be used to initialize a relative initial altitude of the mobile device 110 within physical structure (e.g., providing an offset for measured pressures, initializing a zero value for pressure sensor measurements, etc.).

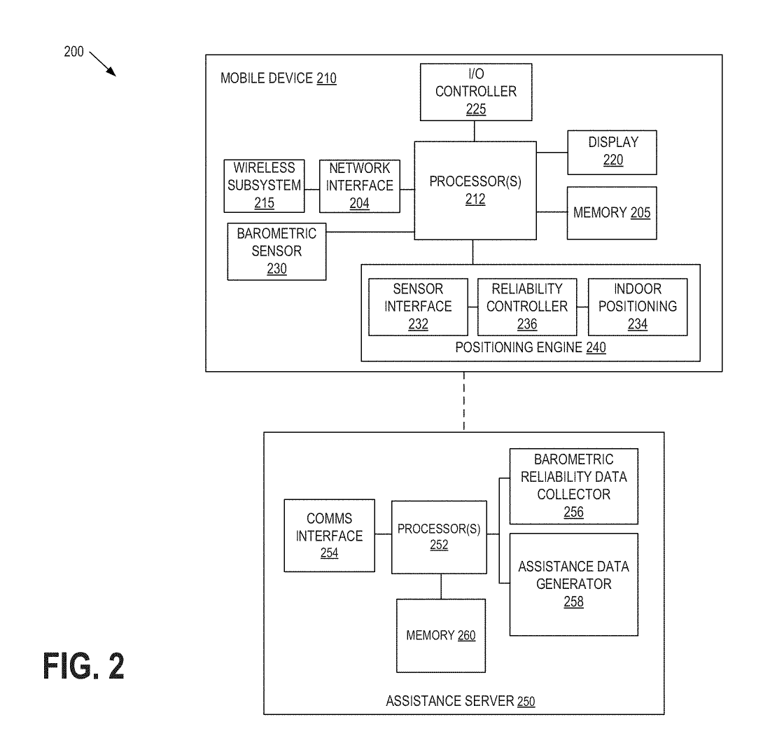

FIG. 2 is block diagram of one embodiment 200 of a mobile device 210 and an assistance server 250. The mobile device 210 and assistance server 250 provide additional details for the mobile device and assistance server discussed above (e.g., mobile device 110 and assistance server 140).

In one embodiment, mobile device 210 is a system, which may include one or more processor(s) 212, a memory 205, I/O controller 225, network interface 204, a barometric sensor 230, and display 220. Mobile device 210 may also include a positioning engine 240 for performing an indoor positioning process utilizing pressure sensor measurement reliability assistance data. In one embodiment, positioning engine 240 includes a number of processing modules, which may be implemented as hardware, software, firmware, or a combination, such as sensor interface 232, reliability controller 236, and indoor positioning engine 234.

It should be appreciated that mobile device 210 may also include, although not illustrated, additional user interfaces (e.g., one or more microphones, keyboard, touch-screen, or similar devices), a power device (such as a battery), as well as other components typically associated with electronic devices. Network interface 204 may also be coupled to a number of wireless subsystems (similar to wireless subsystem 215) (e.g., Bluetooth, WiFi, Cellular, or other networks) to transmit and receive data streams through a wireless link to/from a network (e.g., network 102).

In one embodiment, assistance server 250 is a system, which may also include one or more processors 252, a memory 260, a communications interface 254, and hardware, software, firmware, etc. processing modules, such as barometric reliability data collector 256 and assistance data generator 258. In one embodiment, mobile device 210 and assistance data server may establish a communications link for the exchange of data (e.g., assistance data including pressure sensor measurement reliability data and/or separate pressure sensor measurement reliability data, crowd sourcing data collection, etc.).

Returning to mobile device 210, memory 205 may be coupled to one or more processor(s) 212 to store instructions for execution by processor(s) 212. In some embodiments, memory 205 is non-transitory, such as a non-transitory computer readable storage medium. Memory 205 may also store assistance data received from assistance server 250. Memory 205 may also store positioning engine 240 and one or more modules of the store positioning engine 240 (i.e., sensor interface 232, reliability controller 236, and indoor positioning engine 234) to implement embodiments described herein. It should be appreciated that embodiments of the invention as will be hereinafter described may be implemented through the execution of instructions, for example as stored in the memory 205 or other element, by processor(s) 212 of mobile device 210 and/or other circuitry of mobile device 210 and/or other devices. Particularly, circuitry of mobile device 210, including but not limited to processor(s) 212, may operate under the control of a program, routine, or the execution of instructions to execute methods or processes in accordance with embodiments of the invention. For example, such a program may be implemented in firmware or software (e.g., stored in memory 205 and/or other locations) and may be implemented by processors, such as processor(s) 212, and/or other circuitry of mobile device 210. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by mobile device 210 itself and/or some or all of the functions, engines or modules described herein may be performed by another system, such as assistance server 250 or other system, connected through I/O controller 225 or network interface 204 (wirelessly or wired) to mobile device 210. Thus, some and/or all of the functions for performing indoor positioning and pressure sensor measurement reliability determination may be performed by another system (e.g., assistance server 250) and the results or intermediate calculations may be transferred back to mobile device 210.

In one embodiment, mobile device 210 initiates a positioning process to be performed by positioning engine 240. In one embodiment the positioning process is an indoor positioning process associated with a physical structure (e.g., physical structure 120). The positioning process may be initiated in response to a user request or other user command received through I/O controller 225, as a response to the initiation of an indoor positioning application (e.g., an indoor maps or navigation application), etc. In one embodiment, positioning engine 240 requests indoor positioning assistance data from assistance server 250 at the start of the indoor positioning process. However, in other embodiments, the indoor positioning assistance data may be obtained automatically upon entering a physical structure and/or stored from a prior positioning process performed at the physical structure.

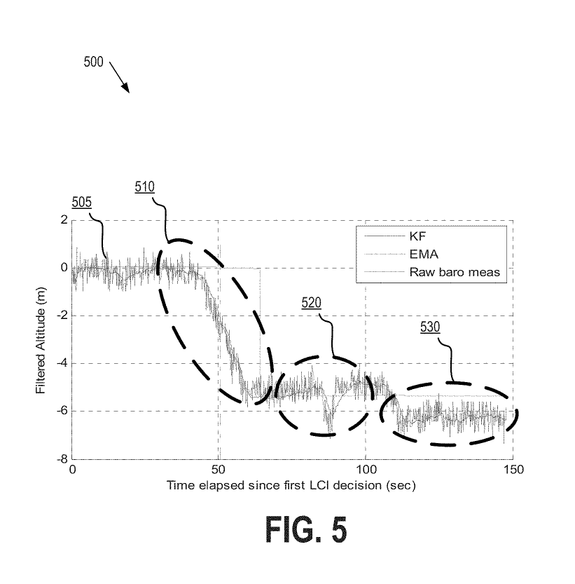

Assistance server 250 responds with the indoor positioning assistance data. In one embodiment, the indoor positioning assistance data includes data that enables a mobile device to determine its location within a physical structure (e.g., a radio heat map) supplemented with pressure sensor measurement reliability information mapped to locations within the physical structure. In another embodiment, the pressure sensor measurement reliability information is provided as separate pressure sensor reliability assistance data that maps locations from the separate pressure sensor reliability assistance data to the indoor positioning assistance data. In either embodiment, assistance data generator 258 of assistance server 250 is responsible for collecting the pressure sensor measurement reliability information from a fingerprinting process and/or one or more mobile devices with barometric reliability data collector 256. The pressure sensor measurement reliability information is collected by assistance server 250 prior to the request from mobile device 210. The fingerprinting data and collected pressure sensor readings enable assistance data generator 258 to determine locations within a physical structure that are to be associated (e.g., mapped) with pressure sensor measurement unreliability, such as locations proximate to environmental control system intakes and outlets, wings of a building with different pressurizations, differences between a pressure outside and inside a physical structure, etc. Based on a known indoor environment (e.g., floor plan, altitude, height of different levels, etc.), assistance data generator detects unexpected deviations in pressure for a given floor plan to determine areas of unreliability of air pressure sensor measurements. FIG. 5 shows an example of barometric pressure changes due to level transitions and due to environmental control systems. In one embodiment, a pressure sensor measurement 505 (e.g., from a fingerprinting process or crowdsourced from a mobile device) can be associated with an initial level of a physical structure. A change in level, that would be experienced when a mobile device travels from an upper level to a lower level will result in a decrease in measured ambient air pressure, as illustrated by the change in region 510. However, an environmental control system air condition outlet may also cause a drop in measured ambient air pressure, as illustrated by region 520, even though the mobile device remains on the same level within the physical structure. Similarly, zones on the same level of a physical structure may have a different pressurization, as illustrated and discussed in FIG. 6, caused by different environmental controls, setup, etc. within the different zones (e.g., a lobby area compared with a computer lab). In one embodiment, assistance data generator 258 locates the zones of potential unreliability when there is a deviation beyond a threshold amount beyond an expected pressure reading (e.g., regions 520 and 530). In one embodiment, assistance data generator 258 generates a mapping in enhanced indoor positioning assistance data and/or separate pressure sensor unreliability assistance data of the physical locations (e.g., points, areas, geofenced boundaries, etc.) of the detected zones having the unexpected pressure readings (e.g., regions 520 and 530) with data indicative of their lack of reliability (e.g., a binary value, an unreliability score, etc.).

In one embodiment, mobile device 210 receives the enhanced indoor positioning assistance data and/or separate pressure sensor unreliability assistance data, and stores the received assistance data in memory 205 for use by positioning engine 240. Indoor positioning engine 234 may then use the indoor positioning assistance data, such as a radio heat map, for estimating an indoor position of a mobile device 210 within a multilevel physical structure. For example, indoor positioning engine can determine on which level mobile device is currently located, and further determine a location within the level mobile device 210 is currently located, based on radio/wireless fidelity signals received by wireless subsystem 215 and their associated characteristics.

Indoor positioning engine 234 further utilizes pressure sensor measurements collected by barometric sensor 230 to supplement and refine, or replace, the level/altitude determination during indoor positioning. However, as discussed herein, reliability controller 236 utilizes the received enhanced indoor positioning assistance data and/or separate pressure sensor unreliability assistance data to determine whether the collected pressure sensor measurements have a certain level of reliability, and therefore can be used in indoor position estimation. In embodiments, reliability controller 236 utilizes the estimated indoor position to check the enhanced indoor positioning assistance data and/or separate pressure sensor unreliability assistance data stored in memory 205, and in particular the mapping of the estimated location to the locations associated with pressure sensor measurement reliability in the received assistance data. When the mapping indicates that the current location of the mobile device 210 is not associated with pressure sensor measurement unreliability, reliability controller 236 passes pressure sensor measurements to indoor positioning engine 234 so that indoor positioning engine 234 can supplement and/or check indoor positioning determinations (e.g., a heat map based determination is enhanced/checked with collected barometric pressure sensor measurements).

In one embodiment, when the mapping indicates that a location is associated with pressure sensor measurement unreliability (e.g., mobile device is at a point, zone, geofenced boundary, etc. mapped to unreliability), reliability controller 236 may instruct barometric sensor 230 to discontinue collecting measurements. Alternatively, measurements may continue to be collected by barometric sensor 230, but reliability controller 236 may instruct indoor positioning engine 234 to ignore and/or discount those measurements when estimating the position of the mobile device 210. In either embodiment, reliability controller continues to instruct barometric sensor to discontinue collecting measurements and/or instruct indoor positioning engine 234 to discount/devalue collected measurements while the mobile device's estimated location is mapped to a region of pressure sensor measurement unreliability. Thus, power may be saved at the mobile device by avoiding use of the barometric sensor 230 when the collected data lacks indoor positioning determination value, and improves indoor positioning determination efficiency by simplifying positioning determination when pressure sensor measurements will not assist (and may mislead) indoor positioning.

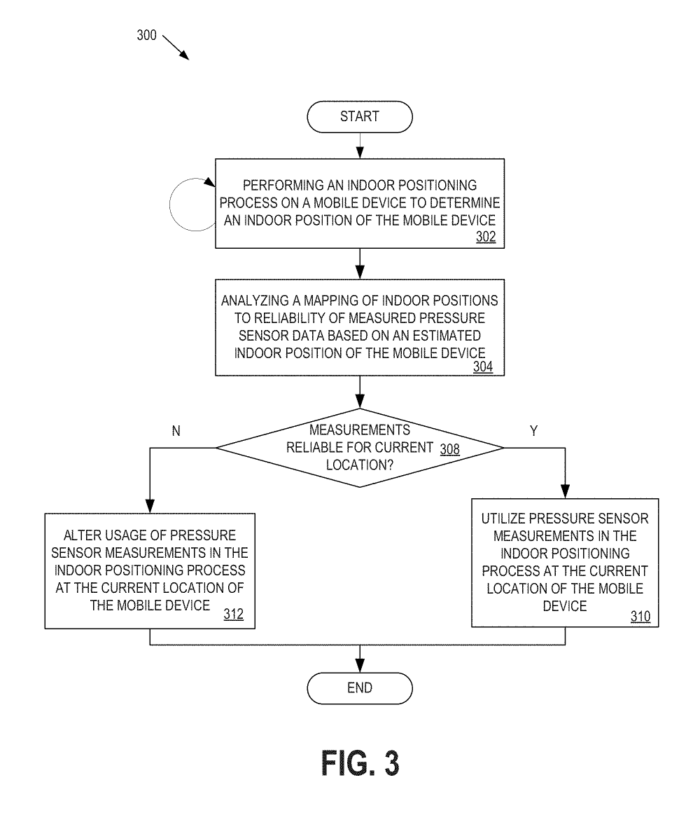

FIG. 3 is a flow diagram of one embodiment of a method for utilizing barometric pressure sensor reliability data while performing an indoor positioning process. The method 300 is performed by processing logic that may comprise hardware (circuitry, dedicated logic, etc.), software (such as is run on a general purpose computer system or a dedicated machine), firmware, or a combination. In one embodiment, the method 300 is performed by a mobile device (such as mobile device 110 or 210).

Referring to FIG. 3, processing logic begins by performing an indoor positioning process on a mobile device to determine an indoor position of the mobile device (processing block 302). As discussed herein, prior to or in response to the indoor positioning process, indoor positioning assistance data is obtained by the mobile device. This indoor positioning assistance data can includes maps, pictures, metadata, etc. for an indoor environment (e.g., a multilevel physical structure), and data that enables mobile device to determine its indoor position (e.g., level, location on a level, distances between features of a level, etc.) within the indoor environment. In embodiments discussed herein, the assistance data may further be supplemented with, or include as separate assistance data, pressure sensor reliability data mapped to locations, regions, zones, etc. of the indoor environment. In embodiments, the mappings between indoor positions and pressure sensor reliability in the assistance data can include an association between any combination of a location, a zone, a region of a floor plan, a geofenced boundary, etc. within the indoor environment with pressure sensor measurement reliability.

Processing logic analyzes the mapping of indoor positions to reliability of measured pressure sensor data based on an estimated indoor position of the mobile device (processing block 304). In embodiments, pressure sensor measurements, such as barometric pressure sensor measurements, may enable the indoor positioning process to refine the estimated indoor position based on, for example, an altitude determined from the pressure sensor measurements, and a level of the indoor environment associated with the determined altitude. However, as discussed herein, indoor environments often employ environmental controls that can alter measured pressure values for certain localities, zones, regions, etc. of the different levels of the indoor environment. Thus, processing logic utilizes the mapping to determine whether pressure sensor measurements at the mobile device's current location are reliable (processing block 308). In embodiments discussed herein, the mapping may be provided within the indoor positioning assistance data received by the mobile device.

When the mapping does indicate that pressure sensor measurements are reliable at the mobile device's current location, processing logic utilizes pressure sensor measurements in the indoor positioning process (processing block 310). As a result, a processor of the mobile device, for example processor(s) 212 of FIG. 2 coupled with memory 205, may be configured to, responsive to the mapping indicating that the current location of the mobile device within the indoor environment is associated with pressure sensor measurement reliability, utilize pressure sensor measurements in the indoor positioning process. In embodiments, mobile device may determine its indoor location without pressure sensor measurements, such as by collecting radio/Wi-Fi signals, determining characteristics associated with the signals, and using a radio heat map to determine the mobile devices current location. In embodiments, the pressure sensor measurements are utilized as a cross-check of the determined indoor location, or to improve the accuracy of the determined location.

However, when the mapping indicates that pressure sensor measurements lack reliability at the mobile device's current location, processing logic alters the usage of the pressure sensor measurements in the indoor positioning process (processing block 312). As a result, a processor of the mobile device, for example processor(s) 212 of FIG. 2 coupled with memory 205, may be configured to, responsive to the mapping indicating that the current location of the mobile device within the indoor environment is associated with an unreliability of pressure sensor measurements, alter a usage of pressure sensor measurements collected by the mobile device for the indoor positioning process. As discussed above, the pressure sensor measurements enable processing logic to enhance and/or cross check an indoor positioning determination. When the pressure sensor measurements are unreliable, based on the mapping from the assistance data, processing logic may take several actions, including stopping a pressure sensor from collecting the measurements while the mobile device remains in the current location by, for example, turning off a pressure sensor, or alternatively continuing to collect pressure measurements and discounting or devaluing the measurements in the indoor positioning process while the mobile device remains in the estimated location.

Processing logic continues to perform the indoor positioning process and analyze the mapping of indoor positions to pressure sensor measurement reliability as the mobile device moves within an indoor environment. Thus, as the mobile device moves between different locations, zones, regions, levels, etc. of the indoor environment, processing logic dynamically adapts the pressure sensor usage to the mobile device's current location and the corresponding pressure sensor measurement reliability. As a result, the pressure sensor measurements can be used when of value to the indoor positioning process, and not used (or altered) when the measurements would lack reliability, thereby saving energy and/or processing resources at the mobile device.

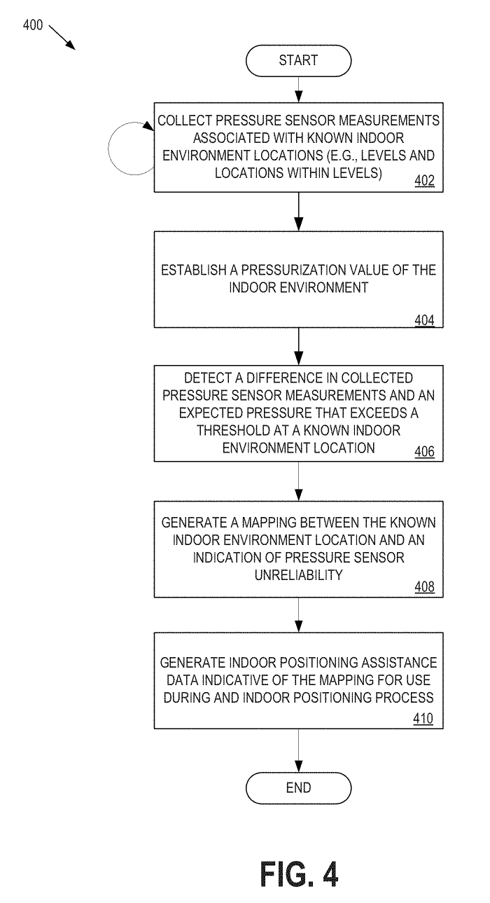

FIG. 4 is a flow diagram of one embodiment of a method for generating one or more types of barometric pressure sensor reliability data for use during an indoor positioning process. The method 400 is performed by processing logic that may comprise hardware (circuitry, dedicated logic, etc.), software (such as is run on a general purpose computer system or a dedicated machine), firmware, or a combination. In one embodiment, the method 400 is performed by an assistance server (such as assistance server 140 or 250).

Referring to FIG. 4, processing logic begins by collecting pressure sensor measurements associated with known indoor environment locations (e.g., levels and locations within levels) (processing block 402). In one embodiment, the pressure sensor measurements can be collected in an offline fingerprinting process by a device having location and pressure sensors, and which know a floor plan/layout of the indoor environment. Alternatively, or in addition to the off-line fingerprinting process, a plurality of mobile devices may report pressure sensor measurements to processing logic, where the measurements can be correlated with known or relative locations of the indoor environment by processing logic. In either embodiment, the pressure sensor measurements may also include measurements of locations outside the building, and locations associated with entering the building. Processing logic is able to use these measurements, from outside and upon entering the building, to establish a pressurization value of the indoor environment (processing block 404). In embodiments the pressurization value can be associated with an offset between a pressure at a ground floor of the indoor environment, and a pressure outside the indoor environment at the same elevation. In embodiments this offset may be included in indoor positioning assistance data to ensure proper indoor position determination by mobile devices.

Processing logic then detects a difference in collected pressure sensor measurements and an expected pressure that exceeds a threshold at a known indoor environment location (processing block 406). In one embodiment, processing logic may know that a certain floor of an indoor environment is located at a given altitude, and would expect pressure sensor measurements in a certain range around that altitude. Process logic would then detect when the collected pressure sensor measurements exhibit a pattern of being outside the expected range of pressure sensor measurement values. For example, pressure sensor reading collected below an air condition output, or within a climate controlled computer lab, may exhibit measured pressures below an expected value. Processing logic, for the locations where the deviation is greater than a threshold, generates a mapping between the known indoor environment location and an indication of pressure sensor unreliability (processing block 408).

The mapping is then integrated into indoor positioning assistance data for use by mobile devices during an indoor positioning process (processing block 410). As discussed herein, the mapping may be integrated into existing indoor positioning assistance data, such as associating locations, zones, regions, etc. of levels of a multi-level indoor environment with unreliability of pressure sensor measurements within the assistance data. In another embodiment, a stand-alone mapping of discrete locations and associated unreliably scores, based on the magnitude of deviation from an expected pressure, may also be generated as assistance data. Other forms of assistance data containing pressure sensor measurement reliability data may be generated and utilized consistent with the discussion herein.

It should be appreciated that when the devices discussed herein are mobile or other computing devices, that they may communicate via one or more wireless communication links through a wireless network that are based on or otherwise support any suitable wireless communication technology. For example, in some aspects computing device or server may associate with a network including a wireless network. In some aspects the network may comprise a body area network or a personal area network (such as an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web-sites, etc.

The teachings herein may be incorporated into (for example, implemented within or performed by) a variety of apparatuses or devices. For example, one or more aspects taught herein may be incorporated into a phone (such as a cellular phone), a personal data assistant (PDA), a tablet, a mobile computer, a laptop computer, an entertainment device (e.g., a music or video device), a headset (e.g., headphones, an earpiece, etc.), a medical device (e.g., a biometric sensor, a heart rate monitor, a pedometer, an Electrocardiography (EKG) device, etc.), a user I/O device, a computer, a server, a point-of-sale device, a set-top box, or any other suitable device.

In some aspects a wireless device may comprise an access device (for example, a Wi-Fi access point) for a communication system. Such an access device may provide, for example, connectivity to another network (e.g., a wide area network such as the Internet or a cellular network) via a wired or wireless communication link. Accordingly, the access device may enable another device (for example, a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for utilizing pressure sensor reliability during indoor positioning performed by a mobile device, the method comprising:
performing an indoor positioning process on the mobile device to estimate a current location of the mobile device within an indoor environment;
analyzing a mapping between indoor positions and pressure sensor measurement reliability;
responsive to the mapping indicating that the estimated current location of the mobile device within the indoor environment is associated with an unreliability of pressure sensor measurements, altering a usage of pressure sensor measurements collected by the mobile device for the indoor positioning process at the estimated current location of the mobile device within the indoor environment.

2. The method of claim 1, wherein altering the usage of pressure sensor measurements collected by the mobile device for the indoor positioning process comprises:
stopping a pressure sensor from collecting the measurements while the mobile device remains in the estimated current location.

3. The method of claim 1, wherein altering the usage of pressure sensor measurements collected by the mobile device for the indoor positioning process comprises:
utilizing the pressure sensor measurements in the indoor positioning process in the estimated current location, wherein the pressure sensor measurements are discounted, devalued, or a combination thereof within the indoor positioning process.

4. The method of claim 1, further comprising:
responsive to the mapping indicating that the estimated current location of the mobile device within the indoor environment is associated with pressure sensor measurement reliability, utilizing pressure sensor measurements in the indoor positioning process.

5. The method of claim 1, wherein the indoor environment is a multilevel physical structure, and the mapping between indoor positions and pressure sensor measurement reliability comprises an association between any combination of a location, a zone, a region of a floor plan, or a geofenced boundary within the indoor environment with pressure sensor measurement reliability.

6. The method of claim 1, wherein the mapping between indoor positions and pressure sensor measurement reliability comprises assistance data obtained by the mobile device from an assistance server.

7. The method of claim 6, wherein the assistance data is generated by the assistance server that identifies at least one location of the indoor environment where collected air pressure measurements at the at least one location differ from an expected air pressure measurement at the at least one location by a threshold air pressure difference.

8. The method of claim 7, wherein the collected air pressure measurements are collected by one or more of an offline fingerprinting device and a plurality of mobile devices.

9. The method of claim 1, wherein the mobile device is a mobile telephone, and wherein the pressure sensor measurements are collected by a barometric pressure sensor of the mobile telephone.

10. A non-transitory computer readable storage medium including instructions that, when executed by a processor, cause the processor to perform a method for utilizing pressure sensor reliability during indoor positioning performed by a mobile device, the method comprising:
performing an indoor positioning process on the mobile device to estimate a current location of the mobile device within an indoor environment;
analyzing a mapping between indoor positions and pressure sensor measurement reliability;
responsive to the mapping indicating that the estimated current location of the mobile device within the indoor environment is associated with an unreliability of pressure sensor measurements, altering a usage of pressure sensor measurements collected by the mobile device for the indoor positioning process at the estimated current location of the mobile device within the indoor environment.

11. The non-transitory computer readable storage medium of claim 10, wherein altering the usage of pressure sensor measurements collected by the mobile device for the indoor positioning process comprises:
stopping a pressure sensor from collecting the measurements while the mobile device remains in the estimated current location.

12. The non-transitory computer readable storage medium of claim 10, wherein altering the usage of pressure sensor measurements collected by the mobile device for the indoor positioning process comprises:
utilizing the pressure sensor measurements in the indoor positioning process in the estimated current location, wherein the pressure sensor measurements are discounted, devalued, or a combination thereof within the indoor positioning process.

13. The non-transitory computer readable storage medium of claim 10, wherein the mapping between indoor positions and pressure sensor measurement reliability comprises assistance data obtained by the mobile device from an assistance server.

14. The non-transitory computer readable storage medium of claim 10, wherein the mobile device is a mobile telephone, and wherein the pressure sensor measurements are collected by a barometric pressure sensor of the mobile telephone.

15. A mobile device that utilizes pressure sensor reliability during indoor positioning, the mobile device comprising:
a pressure sensor;
a memory to store a mapping between indoor positions and pressure sensor measurement reliability for an indoor environment; and
a processor coupled with the memory configured to:
perform an indoor positioning process to estimate a current location of the mobile device within the indoor environment,
analyze the mapping between indoor positions and pressure sensor measurement reliability, and
responsive to the mapping indicating that the estimated current location of the mobile device within the indoor environment is associated with an unreliability of pressure sensor measurements, alter a usage of pressure sensor measurements collected by the mobile device for the indoor positioning process at the estimated current location of the mobile device within the indoor environment.

16. The mobile device of claim 15, wherein the processor configured to alter the usage of pressure sensor measurements collected by the mobile device for the indoor positioning process comprises the processor configured to:
stop the pressure sensor from collecting the measurements while the mobile device remains in the estimated current location.

17. The mobile device of claim 15, wherein the processor configured to alter the usage of pressure sensor measurements collected by the mobile device for the indoor positioning process comprises the processor configured to:
utilize the pressure sensor measurements in the indoor positioning process in the estimated current location, wherein the pressure sensor measurements are discounted, devalued, or a combination thereof within the indoor positioning process.

18. The mobile device of claim 15, wherein the indoor environment is a multilevel physical structure, and the mapping between indoor positions and pressure sensor measurement reliability comprises an association between any combination of a location, a zone, a region of a floor plan, or a geofenced boundary within the indoor environment with pressure sensor measurement reliability.

19. The mobile device of claim 15, wherein the mapping between indoor positions and pressure sensor measurement reliability comprises assistance data obtained by the mobile device from an assistance server.

20. The mobile device of claim 15, wherein the mobile device is a mobile telephone, and wherein the pressure sensor is a barometric pressure sensor.
